(19) United States
(12) Patent Application Publication
(10) Pub. No.: US 2012/0024760 A1
(43) Pub. Date: Feb. 2, 2012

(54) APPARATUS FOR DRYING PELLETS

(75) Inventor: Hans-Walter Hefner, Moembris (DE)

(73) Assignee: AUTOMATIK PLASTICS MACHINERY GMBH, Grossostheim (DE)

(21) Appl. No.: 13/191,529

(22) Filed: Jul. 27, 2011

(30) Foreign Application Priority Data
Jul. 27, 2010 (DE) 102010032350.0

(51) Int. Cl. B07B 4/08

(52) U.S. Cl. 209/3

(57) ABSTRACT

An apparatus for drying pellets having a housing and a device for impressing motion. The device impresses directions of motion on the pellets and on a process fluid that differ locally from one another, so that the process fluid in which the pellets are originally located can be separated. The pellets by means of passage from a screen front to a screen rear in a dewatering region with at least one dewatering screen having dewatering screen openings that are smaller in size than the pellets. A classifying region with at least one classifying screen with classifying screen openings that are of such a size that the pellets of a desired size pass from a screen front through these classifying screen openings to a screen rear, wherein the classifying screen is arranged such that the pellets with the direction of motion impressed upon them pass through the classifying screen openings.

### CROSS REFERENCE TO RELATED APPLICATIONS

The present application claims priority to and the benefit of co-pending International Patent Application No. DE Application No. 102010032350.0, which was filed Jul. 27, 2010, entitled “APPARATUS FOR DRYING PELLETS.” This reference is incorporated in its entirety herein.

### FIELD

The present embodiments generally relate to an apparatus for drying pellets.

### BACKGROUND

A need exists for an apparatus that can operate like a centrifugal dryer or flow dryer that is easy to design and has low maintenance costs and energy consumption.

A further need exists for an apparatus and a method that in addition to allowing clean drying, also permits automated, and hence reliable, classifying in a structurally simple manner.

The present embodiments meet these needs.

### BRIEF DESCRIPTION OF THE DRAWINGS

The detailed description will be better understood in conjunction with the accompanying drawings as follows:

FIG. 1 is a schematic longitudinal cross-section of a portion of an apparatus for drying pellets according one or more embodiments.

FIG. 2 is a schematic longitudinal cross-section of a portion of an apparatus for drying pellets according to one or more embodiments.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The apparatus disclosed herein can be used to dry pellets, made, e.g., of a plastic material. The apparatus can include a housing. A device can be located therein for impressing motion. The device can cause the directions of motion of the pellets to differ locally from the direction of the process fluids and impresses directions of motion on the pellets and on a process fluid.

The device can separate pellets from the process fluid. The process fluid can separate from the pellets as the process fluid passes through a screen front to a screen back of a dewatering screen in a dewatering region. The process fluid can be any fluid. An illustrative process fluid is water.

The apparatus, in addition to being equipped and designed for drying pellets, as described above, can also have a classifying region with at least one additional classifying screen having classifying screen openings that are of such a size that the pellets with a desired size pass from a screen front through these classifying screen openings to a screen rear, wherein the classifying screen is arranged such that the pellets with the direction of motion impressed upon them by the device for impressing motion, pass through the classifying screen openings there. With the additional classifying region, both the separation of the pellets and process fluid as well as the simultaneous or subsequent classifying of the pellets into different sizes can take place in a simple and economical manner, in particular in a compact housing of the apparatus.

The classifying region can be arranged downstream of the coolant flow with the pellets located therein, or downstream of the primary flow direction of the pellets already separated from the coolant, and/or can be arranged in the same housing of the apparatus as the dewatering region for separating the coolant from the pellets, which is to say above or below the dewatering region, for example.

According to an embodiment, the device for impressing motion can be, for example, a rotor with rotor blades that is arranged in the housing such that it can be driven in rotation, for example driven by a motor, wherein the dewatering screen and the at least one additional classifying screen are arranged about the rotor at least in sections, and wherein the rotor is located in the region of the applicable screen front and the housing is located in the region of the applicable screen rear. The essentially concentric arrangement with the rotor in the inside and the arrangement of the classifying screen and dewatering screen arranged around it, and with the surrounding envelope of the housing outside. Such a construction is especially compact and can be manufactured economically.

If a rotor is used as the device for impressing motion, then the rotor arrangement can correspond to the conventional construction of a centrifugal dryer, such as CENTRO from Automatik Plastics Machinery GmbH of Germany.

According to another embodiment, the device for impressing motion can also be one or more air nozzles. The one or more nozzles can be oriented to provide airflow from the screen fronts of both the dewatering screen and the classifying screen, an airflow onto and through the at least one dewatering screen and the at least one additional classifying screen. The corresponding air flow can include air or suitable gas, such as an inert gas, such as nitrogen, for example, can provide an additional drying action for the pellets.

In addition, for supporting the process of separating the coolant and pellets, or for supporting the process of separating pellets of different sizes, at least one applicable flushing fluid nozzle can be provided on an applicable screen rear of the dewatering screen and/or classifying screen in the dewatering region and/or in the classifying region, where the nozzle is arranged to be oriented opposite to the impressed direction of motion of the process fluid or of the pellets. As a result, in the event of possible clogging or impending blockage of the screen openings in the dewatering screen and/or classifying screen, the opening can be “blown” free again in that a flushing fluid, for example water or air, directed opposite to the screen passage direction through the screen forces the clogging elements away, opposite the actual screen action direction. In this way, reliable and additionally improved operation can be achieved at all times in a simple manner.

To ensure a possible spatial separation of the dewatering region and the classifying region in a functional regard as well and to prevent coolant from potentially passing from the dewatering region to the classifying region to a relatively great degree, it is possible according to an embodiment of the apparatus for the dewatering region and the classifying region to be separated from one another in a fluid-tight manner. For example, a partition can be located at an applicable screen rear of the dewatering screen and/or classifying screen. The partition can allow the pellets to be evacuated through an outlet opening formed into the housing and prevent the pellets from reentering the dewatering section. The classified pellets can be prevented from reentering the dewatering region, instead of which they can be discharged from the classifying region and out of the housing through an outlet opening. A corresponding partition can also be provided between an outlet region for oversize pellets or agglomerates and the classifying region, so that no oversized pellets or agglomerates get into the region of the screen rear of the classifying screen, and the oversized pellets and agglomerates can be discharged out of the housing through the outlet region in an especially reliable manner.

An additional counter flow nozzle can be provided to remove residual coolant still adhering to the pellets. A counter flow of air can be produced opposite the direction of motion locally impressed on the pellets in the device for impressing motion and remove residual coolant from the pellets.

The apparatus can be configured to impress motion on the pellets, process fluid, or both that forces at least a portion of the pellets, the process fluid, or both through the dewatering screen openings, classifying screen openings, or both, with the result that pellets of a certain size are thus separated from other pellets, or the pellets and process fluid are separated from one another, by the passage through the applicable screen openings. The force component used here can be a centrifugal force component that moves the process fluid or the pellets centrifugally in an otherwise impressed curved motion, in particular a spiral motion, namely by the device for impressing motion.

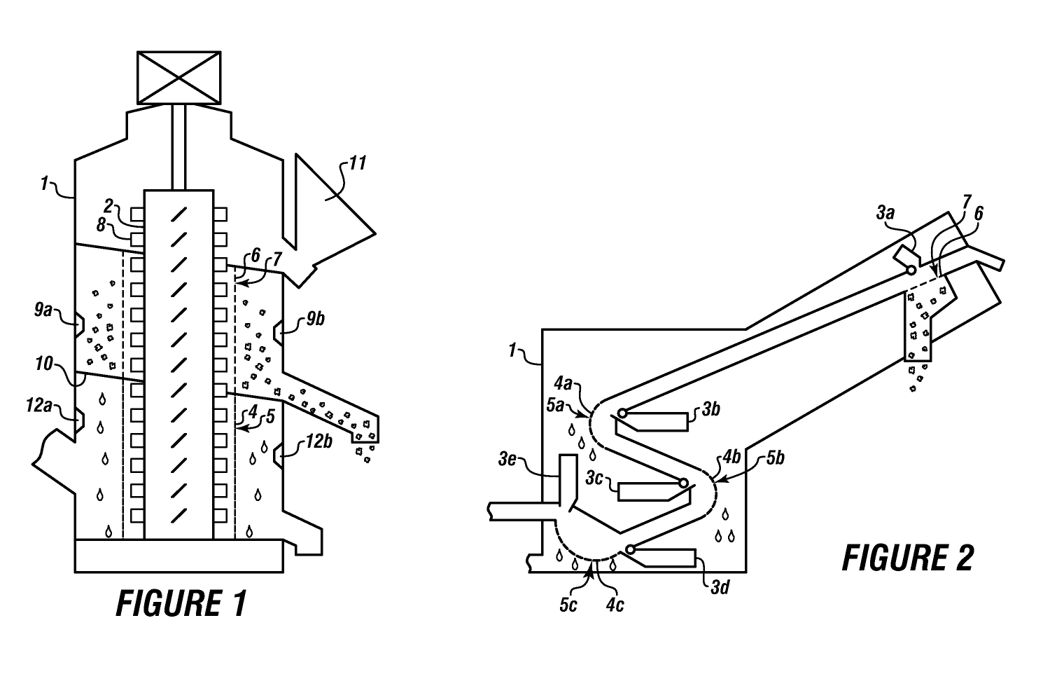

FIG. 1 shows a schematic longitudinal cross-section of a portion of an apparatus for drying pellets according to one or more embodiments. The apparatus has a housing 1. A rotor 2 with rotor blades 8 can be disposed within the housing 1 as a device for impressing motion. The rotor 2 can impress a direction of motion on the pellets and a process fluid that differs locally in each case because of the different centrifugal force components acting because, for example, of the different inertial forces acting. The process fluid with the pellets located therein is supplied to the apparatus through an inlet in the housing 1, and then transported further upward by the rotor 2 with the rotor blades 8 in an essentially spiral motion, with the process fluid that originally contained the pellets being separated, radially to the outside, from the pellets in the bottom third of the housing 1 in a dewatering region. The dewatering region is formed by a dewatering screen 4 with dewatering screen openings 5 that are smaller in size than the pellets, wherein the process fluid is forced outward there by the centrifugal motion and through the dewatering screen openings 5, but the pellets do not pass through there, and hence are moved further upward in the housing 1 in a spiral motion. The rotor 2 can be driven by an electric motor.

Following the dewatering screen 4 arranged around the rotor 2, with the rotor blades 8 in the region of the screen front and the housing 1 in the region of the screen rear, is an adjoining classifying region with at least one classifying screen 6 with classifying screen openings 7, wherein the classifying screen openings 7 are of such a size that the pellets with a desired size pass through them from the screen front there to the screen rear there, wherein the classifying screen 6 is arranged such that the pellets with the direction of motion impressed upon them pass through the classifying screen openings 7 there. According to the embodiment shown in FIG. 1, the classifying screen 6 is adjacent directly above the dewatering screen 4 and, like the dewatering screen 4, is arranged concentrically around the rotor 2 in the housing 1. As can be seen in FIG. 1, an outlet is provided in the housing 1, at the right in the lower region of the classifying region in the housing 1; the appropriately classified pellets of the desired size can exit through this outlet.

Above the classifying region in the apparatus depicted in FIG. 1 is another adjoining region, into which the oversized pellets, agglomerates, and remaining pellets of desired size that were not discharged in the classifying region, are transported by the rotor 2, where they can be discharged from the housing 1 through an outlet located to the right in FIG. 1. Provided in this discharge region is a counter flow nozzle 11, by means of which a counter flow of air can be produced in a direction opposite the direction of motion impressed on the pellets by the device for impressing motion, namely the rotor 2. This increases the drying performance of the apparatus to a particular degree.

At the respective screen rears, which is to say at the radially outward regions in the housing 1 in the region of the dewatering screen 4 and classifying screen 6, the dewatering region and the classifying region are separated from one another in a fluid-tight manner by a partition 10 that is arranged circumferentially and is angled toward a suitable outlet opening; among other things, this partition 10 ensures that the classified pellets cannot fall back downward into the dewatering region, but instead are discharged from the classifying region through the outlet opening shown on the right in FIG. 1. Toward the top as well, the classifying region is partitioned off from the outlet region for oversized pellets or agglomerates by an appropriate partition, which likewise is angled so that no oversized pellets or agglomerates get into the region of the screen rear of the classifying region, and the oversized pellets or agglomerates can be discharged there through the outlet region. The partition/partitions can also be designed in the form of a truncated cone sloping radially outward toward the housing 1.

In the classifying region, flushing fluid nozzles 9a and 9b are provided at the applicable screen rear of the classifying region, where the flushing fluid nozzles 9a and 9b are arranged to be oriented opposite to the impressed direction of motion of the pellets. In the dewatering region, flushing fluid nozzles 12a and 12b are provided at the applicable screen rear of the dewatering screen 4, where the flushing fluid nozzles 12a and 12b are arranged to be oriented opposite to the impressed direction of motion of the process fluid or of the pellets. The flushing fluid nozzles 9a and 9b can, in particular, blow air or an inert gas, periodically during cleaning cycles, radially inward onto the classifying screen 6 that is arranged radially around the rotor 2, so that possible blockages of the classifying screen openings 7 can be blown away. The flushing fluid nozzles 12a and 12b can, in particular, spray water or another coolant, periodically during cleaning cycles, radially inward onto the dewatering screen 4 that is arranged radially around the rotor 2, so that possible blockages of the dewatering screen openings 5 can be flushed away.

FIG. 2 shows a schematic longitudinal cross-section of a portion of an apparatus for drying pellets according to an embodiment. The embodiment of the apparatus as shown in FIG. 2 does not use centrifugal force, imparted by the rotational motion of the rotor, for drying and classifying, but instead uses an airflow or airflows from at least one air nozzle 3a, 3b, 3c, 3d and 3e, which are arranged appropriately in a housing 1. According to the embodiment in FIG. 2, the process fluid and the pellets located therein are fed into the housing 1 from below at left, and immediately after entering the housing are subjected to an airflow, which in each case acts upon the pellets and the process fluid from the screen front of at least one dewatering screen 4a and 4b with at least one dewatering screen openings 5a and 5b. The pellets can move through several redirection stages. For example, FIG. 2 depicts the pellets being conducted through a corresponding guidance system in the housing 1 in three redirection stage. The corresponding guidance system can include at least one air nozzle, such as air nozzles 3a, 3b, 3c, 3d and 3e and the dewatering screens 4a and 4b being provided at each of the redirection points, so that the process fluid can be stripped away from the pellets there and expelled through the applicable screen openings. Provided in the lower region of the housing 1 is an opening with a pipe through which the process fluid can be discharged. Arranged in the upper region of the housing 1, in addition to the dewatering region described, is the classifying region with a classifying screen 6 with classifying screen openings 7 that are of such a size that the pellets of a desired size pass from a screen front through these classifying screen openings 7 to a screen rear, and then are discharged downward out of the housing 1 through an outlet. During this process, a motion is accordingly impressed on the pellets by at least one air nozzle 3a, 3b, 3c, 3d and 3e at the screen front of the classifying screen 6. Shown at the top right in the representation in FIG. 2 is an outlet from the housing 1 that is connected to the guidance system in the housing 1. Through this outlet, oversize pellets can exit from the housing 1 and be collected there.

While these embodiments have been described with emphasis on the embodiments, it should be understood that within the scope of the appended claims, the embodiments might be practiced other than as specifically described herein.

What is claimed is:

1. An apparatus for drying pellets comprising:
a. a housing;
b. a device for impressing motion disposed within the housing; wherein the device for impressing motion impresses directions of motion that differ locally from one another onto the pellets and onto a process fluid, so that the process fluid in which the pellets are originally located can be separated from the pellets by means of passage from a screen front to a screen rear in a dewatering region having at least one dewatering screen with dewatering screen openings that are smaller in size than the pellets; and
c. a classifying region within the housing, wherein the classifying region has at least one classifying screen, wherein the at least one classifying screen has classifying screen openings that are of such a size that the pellets of a desired size pass from a screen front through the classifying screen openings to a screen rear, wherein the at least one classifying screen is arranged such that the pellets with the direction of motion impressed upon them pass through the classifying screen openings there.

2. The apparatus of claim 1, wherein the device for impressing motion is a rotor with rotor blades that is arranged in the housing such that it can be driven in rotation, wherein the at least one dewatering screen and the at least one classifying screen are arranged about the rotor at least in sections, and wherein the rotor is located in the region of the applicable screen front and the housing is located in the region of the applicable screen rear.

3. The apparatus of claim 1, wherein the device for impressing motion is at least one air nozzle.

4. The apparatus of claim 3, wherein at least one flushing fluid nozzle is provided on an applicable screen rear of the at least one classifying screen, wherein the flushing fluid nozzle is arranged to be oriented opposite to the impressed direction of motion of the pellets.

5. The apparatus of claim 4, further comprising at least one flushing fluid nozzle on an applicable screen rear of at least one dewatering screen in the dewatering region, where the flushing fluid nozzle is arranged to be oriented opposite to the impressed direction of motion of the process fluid or of the pellets.

6. The apparatus of claim 1, further comprising a flushing fluid nozzle on an applicable screen rear of the at least one classifying screen, where the flushing fluid nozzle is arranged to be oriented opposite to the impressed direction of motion of the pellets.

7. The apparatus of claim 1, wherein a relevant screen rear of the at least one dewatering screen, the at least one classifying screen, or combinations thereof in the dewatering region and the classifying region are separated from one another in a fluid-tight manner by a partition.

8. The apparatus of claim 1, wherein a counter flow nozzle is provided, by means of which a counter flow of air can be produced in the device for impressing motion opposite to the direction of motion locally impressed on the pellets.
